(19) United States
(12) Patent Application Publication
(10) Pub. No.: US 2003/0071379 A1
(43) Pub. Date: Apr. 17, 2003

(54) Method for fabricating multi-colored ball, and method for fabricating display device

(75) Inventors: Naoyuki Hayashi, Kawasaki (JP); Shino Tokuyo, Kawasaki (JP); Mitsuo Ozaki, Kawasaki (JP); Norio Sawatari, Kawasaki (JP)

Correspondence Address: Patrick G. Burns, Esq., GREER, BURNS & CRAIN, LTD., Suite 2500, 300 South Wacker Dr., Chicago, IL, 60606, US

(73) Assignee: FUJITSU LIMITED

(21) Appl. No.: 10/100,961

(22) Filed: Mar. 19, 2002

(30) Foreign Application Priority Data
Oct. 12, 2001 (JP) 2001-315884

(51) Int. Cl. B29D 11/00

(52) U.S. Cl. 264/1.9

(57) ABSTRACT

The method for fabricating a multi-colored ball comprises the steps of: applying to a resin sheet 14 having a first color and a first charge characteristic a solution 16 containing at least a resin and/or a monomer which is a precursor of a resin, and a coloring agent having a second color and a second charge characteristic; polymerizing or drying the solution to thereby form a resin sheet 18 having the second color and the second charge characteristic on the resin sheet 14; cutting or milling a laminate of the resin sheet 14 and the resin sheet 18; and sphering the cut or milled laminate by heating to form multi-colored ball having a first region having the first color and the first charge characteristic and a second region having the second color and the second charge characteristic. Whereby the resin sheet 18 is formed on the resin sheet 14 without rolling, so that the resin sheet 18 can be easily formed in a uniform thickness.

### CROSS-REFERENCE TO RELATED APPLICATIONS

This application is based upon and claims priority of Japanese Patent Application No. 2001-315884, filed on Oct. 12, 2001, the contents being incorporated herein by reference.

### BACKGROUND OF THE INVENTION

The present invention relates to a method for fabricating multi-colored balls used in a sheet-type display device, more specifically to a method for fabricating multi-colored balls which can produce micronized multi-colored balls simply and at low costs.

Recently, as information devices have been widely used, sheet-type display devices, which are called electronic papers, paper-like displays, digital papers or others, and which each comprise a display layer between a counter electrode, and a potential difference is applied between the counter electrode to change absorption index or reflectivity so as to display images are noted.

As elements for changing optical absorption and optical reflection in such sheet-type display devices, micro capsules each enclosing, together with an insulating liquid, a rotary particle formed of mated hemispheres which are different from each other both in color and electric characteristics; micro capsules enclosing a colored solvent containing electrophoretic particles dispersed as described in the Laid Open Patent Application No. Shou 64-86116 (1989); a liquid crystal/high polymer composite film containing dichromatic dye and a smectic liquid crystal, etc. are proposed.

The sheet-type display devices using such elements are able to retain image information without power supply and are reflective display device. Thus, they are prospective as a substitute of paper. Structurally, the sheet-type display devices simply comprises the elements applied to PET (polyethylene terephthalate) film having electrodes, and are thin and light, and bendable.

Among such sheet-type display devices, the sheet-type display devices described in, e.g., the specification of U.S. Pat. No. 4,126,854 and the specification of U.S. Pat. No. 4,143,103 use multi-colored balls each having hemispheres of different colors and different charge characteristics and have better contrast characteristics in comparison with the rest sheet-type display devices.

Then, the sheet-type display devices described in the specification of U.S. Pat. No. 4,126,854 and the specification of U.S. Pat. No. 4,143,103 will be explained with reference to FIGS. 3 and 4A-4C.

As shown in FIG. 3, a PET film 62 is formed on a common electrode 60. A silicone rubber layer 64, which is optically transparent layer, is formed on the PET film 62. A plurality of voids 66 formed in the silicone rubber layer 64, filled with a dielectric liquid. Multi-colored balls 72 each having a black-color region 68 and a white-color region 70 which are different from each other in color and electrical charge characteristics are disposed in the respective voids 66 in the silicone rubber layer 64. A diameter of the multi-colored balls 72 is smaller than a diameter of the voids 66 so that the respective multi-colored balls can rotate in the voids 66. A PET film 74 is formed on the silicone rubber layer 64. Discrete electrodes 76 are formed on the PET film 74.

The multi-colored balls 72 have the black-color region 68, e.g., positively charged and the white-color region 70, e.g., negatively charged. When a voltage is applied between the discrete electrodes 76 and the common electrode 60, the multi-colored balls 72 has electrophoresis and rotary motions in accordance with a polarity of the electric field, and images can be displayed. That is, as shown in FIG. 4, when no electric field is applied, the multi-colored balls 72 are directed at random (FIG. 4A). When a positive voltage is applied to the common electrode 70 with the discrete electrodes 76 grounded, the multi-colored balls 72 rotate to have the black-color regions 68 directed toward the discrete electrodes 76 (FIG. 4B). Similarly, when a positive voltage is applied to the discrete electrode 76 with the common electrode 70 grounded, the multi-colored balls 72 rotate to have the white-color regions 70 directed toward the discrete electrodes 76 (FIG. 4C).

The following methods, for example, for fabricating the multi-colored balls used in the sheet-type display devices and materials forming the multi-colored balls are proposed.

The specification of U.S. Pat. No. 5,262,098 discloses a method of combining melted wax particles of 2 different colors, forming them into spheres by surface tension, and hardening them, whereby multi-colored balls are formed. As materials of the multi-colored balls are carnauba wax, carbon black and titanium dioxide are used.

The Laid-Open Japanese Patent Application No. Hei 11-85067 (1999) and the Laid-Open Japanese Patent Application No. Hei 11-85068 (1999) disclose a method of vapor depositing metal, carbon black, antimony sulfide, etc. on the surfaces of particles of glass, a resin or others to thereby form multi-colored balls.

The Laid-Open Japanese Patent Application No. Hei 11-85069 (1999) and the Laid-Open Japanese Patent Application No. Hei 11-161206 (1999) discloses a method of coloring particles of a photosensitive material by exposure, development and fixation to thereby form multi-colored balls. As materials of the multi-colored balls, zinc oxide (colored by toner), hydrophilic polymer (colored by silver halide), etc. are used.

The Laid-Open Japanese Patent Application No. Hei 1-282589 (1989) discloses a method of forming a rolled sheet of adhered resins of two-colors into by a roller or a press, milling the sheet, and forming into multi-colored balls by heating with hot air.

The specification of Japanese Patent Application No. 2000-317624 discloses a method of forming resins colored with 2 different color pigments into a sheet or fibers, cutting the sheet or the fibers into resin pieces, and melting the cut resin pieces, whereby multi-colored balls are formed.

Among the above-described methods, the method of rolling or forming into fibers adhered resins of two colors is considered effective to micronize display devices, because the method can produce particles of, e.g., an about 100 μm-diameter with high accuracy. However, in this method, resins of different colors tend to separate from each other in the interface therebetween in the processes of rolling and cutting the resins.

Furthermore, in order to make the diameter of the particles smaller, the sheet or the fibers of the resins must be cut into smaller sizes. Otherwise, the sheet of the resins must be made thinner, or the fibers must be made thinner. However, there is a limit to a size for the sheet or the fibers to be cut into. It is difficult to evenly roll the resins or make the resins into uniform fibers because of different melt viscosities of the different color resins.

### SUMMARY OF THE INVENTION

An object of the present invention is to provide a multi-colored ball forming method which can form micronized multi-colored balls without rolling.

According to one aspect of the present invention, there is provided a method for fabricating a multi-colored ball comprising the step of: applying to a first resin sheet having a first color and a first charge characteristic a solution containing at least a resin and/or a monomer which is a precursor of a resin, and a coloring agent having a second color and a second charge characteristic; polymerizing or drying the solution to thereby form a second resin sheet having the second color and the second charge characteristic on the first resin sheet; cutting or milling a laminate of the first resin sheet and the second resin sheet; and sphering the cut or milled laminate by heating to form a multi-colored ball having a first region having the first color and the first charge characteristic and a second region having the second color and the second charge characteristic.

According to another aspect of the present invention, there is provided a method for fabricating a display device which display by rotating a multi-colored ball having 2 surface regions having optical characteristics different from each other, the method comprising the steps of: forming a multi-colored ball by an above-described method for fabricating a multi-colored ball; dispersing the multi-colored ball in a transparent display medium and curing the same to thereby form a sheet-type display layer containing the multi-colored ball; and forming electrodes respectively on a front surface of the display layer and a back surface thereof.

As described above, according to the present invention, a solution containing at least a resin and/or a monomer which is a precursor of a resin, and a coloring agent having a second color and a second charge characteristic is applied to a first resin sheet having a first color and a first charge characteristic, and is polymerized or dried to thereby form a second resin sheet of the second color and the second charge characteristics on the first resin, whereby the resin sheets can be easily formed in a uniform thickness without the use of rolling. A laminate of thin resin sheets can be formed without considering melting viscosities, etc. of different-color resins.

### BRIEF DESCRIPTION OF THE DRAWINGS

FIGS. 1A-1E are sectional views of a laminate of resin sheets used in the method for fabricating the multi-colored ball according to the present invention in the steps of the method for fabricating the same, which show the method.

FIGS. 2A-2F are sectional views of the sheet-type display device in the steps of the method for fabricating the same, which show the method.

FIG. 3 is a diagrammatic sectional view of the sheet-type display device, which shows a structure thereof.

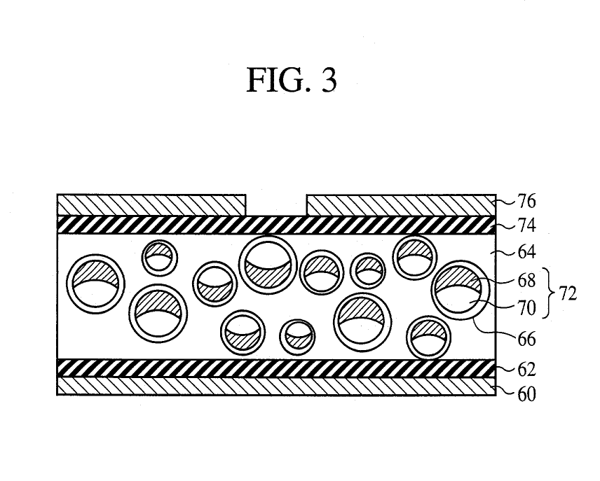

FIGS. 4A-4C are views of the sheet-type display device, which explain operations thereof.

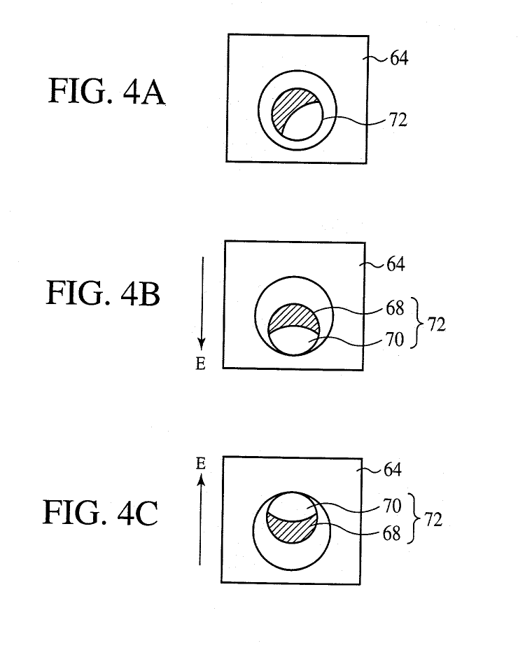

### DETAILED DESCRIPTION OF THE INVENTION

The method for fabricating a multi-colored ball according to the present invention is characterized mainly in that the method comprises the steps of: applying to a first resin sheet having a first color and a first charge characteristics a solution containing at least a resin and/or a monomer which is a precursor of a resin, and a coloring agent having a second color and a second charge characteristic; polymerizing or drying the solution to form on the first resin sheet the second resin sheet having the second color and the second charge characteristic; cutting or milling the laminate of the first resin sheet and the second resin sheet; and sphering the cut or milled laminate by heating to form multi-colored ball having regions different from each other in color and charge characteristic.

As described above, in the method for fabricating the multi-colored ball according to the present invention, the second resin sheet is formed on the first resin sheet without rolling, so that the resin sheet can be easily formed in a uniform thickness.

The first resin sheet may be formed in the same way as the second resin sheet, or may be prepared by forming a resin having a first color and first charge characteristics into a sheet by rolling or other means. In forming a resin sheet of one color, it is not necessary to consider melt viscosities, etc. of a resin of a different color, and the resin sheet of one color can have a uniform thickness even by rolling. When the first resin sheet is formed in the same way as the second resin sheet, a prescribed solution is applied to a glass substrate or a substrate, such as a plastic sheet or others, to thereby form the resin sheet. For easy release of the resin sheet from the substrate, a surface treatment may be made with Teflon (registered trademark) or a release agent.

The practical thickness of the laminate of the resin sheets is about 1-1000 μm. The method according to the present invention can easily form the laminate of the sheets of a thickness in this range.

For forming resin sheets in the method for fabricating the multi-colored ball according to the present invention, the following 3 methods, for example, are considered.

In the first method, a solution containing a coloring agent, a polymerization initiator and a monomer is applied and then polymerized to thereby form the resin sheet.

When the solution is applied to a resin sheet, the resin in the resin sheet absorbs the monomer in the solution at the interface between the substrate resin sheet and the solution. In this state, heating forms the resin through the interface, and a laminate of the resin sheets of high strength can be prepared.

It is preferable that the solution containing the coloring agent, the polymerization initiator and the monomer has a viscosity of about 3-100 Pa·s. Such viscosity of the solution enables a thickness of the applied solution to be easily controlled. The low viscosity of the solution makes it easy to form a thin layer.

In the second method, a solution containing a coloring agent, a polymerization initiator and a monomer is polymerized to form a prepolymer. Then, the prepolymer is applied and further polymerized to thereby form the resin sheet.

When the prepolymer is applied to a substrate resin sheet, the resin in the resin sheet absorbs the monomer in the prepolymer at the interface between the substrate resin sheet and the prepolymer. In this state, heating forms the resin through the interface, and a laminate of the resin sheets, which has high strength can be prepared.

A prepolymer means a state which is not completely polymerized and contains both a resin and a monomer. In consideration of the purpose of preparing the resin sheet of the present invention, the prepolymer preferably has a viscosity of about 3-100 Pa·s. Such viscosity of the solution enables a thickness of the applied solution to be easily controlled. The low viscosity of the solution makes it easy to form a thin layer.

In the third method, an organic solvent dissolving a resin containing a coloring agent is applied and dried to thereby form a resin sheet.

When the solution containing the resin is applied to the substrate resin sheet, swelling or dissolution takes place at the surface of a resin sheet causes entanglement between the substrate resin sheet and the resin in the solution. The solution is dried to thereby form a laminate of the resin sheets, which has high strength.

It is preferable that the solution containing a resin has a viscosity of about 3-100 Pa·s. Such viscosity of the solution enables a thickness of the applied solution to be easily controlled. The low viscosity of the solution makes it easy to form a thin layer.

Monomers having one ethylene-type unsaturated bond in one molecule can be used in the above-described first and the second methods. Such monomers are exemplified by styrene-based monomers, such as styrene, o-methylstyrene, m-methylstyrene, p-methylstyrene, p-ethylstyrene, 2,4-dimethylstyrene, p-phenylstyrene, p-chlorostyrene, 3,4-dichlorostyrene, p-n-butylstyrene, p-tert-butylstyrene, p-n-hexylstyrene, p-n-octylstyrene, p-n-dodecylstyrene, etc., vinyl ester-based monomers, such as vinyl acetate, vinyl propionate, vinyl butylate, etc., ester acrylate-based monomers, such as methyl acrylate, n-butyl acrylate, isobutyl acrylate, n-propyl acrylate, n-octyl acrylate, dodecyl acrylate, 2-ethylhexyl acrylate, stearyl acrylate, 2-chloroethyl acrylate, phenyl acrylate, etc., ester methacrylate-based monomers, such as methyl methacrylate, n-butyl methacrylate, isobutyl methacrylate, n-propyl methacrylate, n-octyl methacrylate, dodecyl methacrylate, 2-ethylhexyl methacrylate, stearyl methacrylate, 2-chloroehtyl methacrylate, phenyl methacrylate, etc., vinyl ether-based monomers, such as vinyl methyl ether, vinyl ethyl ether, vinyl isobutyl ether, etc., acrylic acid, such as acrylnitrile, methacrylnitrile, acrylamide, etc., and vinyl-based monomers, such as methacrylic acid derivatives. These monomers may be used singly, or combinations of 2 or more may be used.

When butyl acrylate is added to styrene monomer, a melting viscosity of the resin is lowered, which easily makes particles spherical. The addition amount increase of butyl acrylate makes decrease rates of the melting viscosity higher. When a mixture of styrene monomer and butyl acrylate is used, it is preferable to add butyl acrylate by 0.1-70 weight % to styrene monomer.

To control a molecular weight distribution, divinyl benzene, divinyl naphthalene, divinyl ether or others as a crosslinking agent may be used in combination with these monomers.

Polymerization initiators are added in advance to these monomers. The polymerization initiators are azo-based compounds, such as 2,2-azobis(2,4-dimethylvaleronitrile), 2,2-azobis(isobutylonitrile), etc., specifically V-30, V-49, V-59, V-65, V-70, V-085 (by Wako Pure Chemical Industries, Ltd.). A content of the polymerization initiators is normally 0.01-10 weight % of a monomer mixture.

Coloring agent as a white pigments to be mixed with these monomers are known pigments, such as titanium dioxide, barium titanate, calcium carbonate, alumina, zinc oxide, silicon dioxide, etc. For higher chromaticity, preferably titanium dioxide of more preferably a 200-300 nm-particle size rather than of a 100-500 nm-particle size, whose masking rate is high, is used. Especially the use titanium dioxide of the anatase-type crystal structure can further enhance the reflectivity. Coloring agent as a black pigments to be mixed with these monomers are known pigments and dyes, such as carbon black, magnetite, aniline black, composite oxides, as of copper, cobalt, iron, manganese, chrome, etc. For higher dispersion and the prevention of discoloration of the resins, surface treatments with inorganic substances, silane compounds, resins, etc. may be made. In addition to the pigments and dyes, for the control of electric characteristics of the particles, inorganic substances, e.g., calcium salts, such as tricalcium phosphate, calcium chloride, calcium oxide, etc. may be suitably mixed. Coloring agents to be added to the monomers are selected so as to make a hue different from that of the substrate resin sheet. Coloring agents may not be essentially for the black and white combination.

The monomers may be UV curing resins mixed with the coloring agents and the polymerization agents. The UV curing resins are known resins, as of ester-base, urethane-base, urethane acrylate-base, epoxy-base, polyether-base, etc.

Resins used in the above-described third method can be polyester resin, polystyrene resin, acrylic resin, etc., which are soluble and thermoplasticity. A solvent for these resins is one of alcohol, ketone, ester and chlorinated solvent, or a mixture of them.

In forming the resin sheet by the above-described first method, the above-described monomer, the polymerization initiator, the pigment, etc. are mixed and applied to the substrate resin sheet, and heated to advance the polymerization, and a laminate of the resin sheets is prepared.

In forming the resin sheet by the above-described second method, the above-described monomer, the polymerization initiator and the pigment are mixed, and agitated while being heated to thereby prepare a solution (prepolymer) having an increased viscosity by the polymerization. The solution is applied to the substrate resin sheet and further heated to advance the polymerization, and a laminate of the resin sheets is prepared.

In forming the resin sheet by the above-described third method, a soluble, thermoplastic resin, such as polyester resin, polystyrene resin, acrylic resin or others, is kneaded with the above-described coloring agent, etc. by a kneader, a roll mill or other means. The thus colored resin is dissolved in one of alcohol, ester, ketone, and chlorinated solvent, or a mixture of them, and applied to the substrate resin sheet and dried to thereby prepare a laminate of the resin sheets. To laminate the resin sheets it is necessary that the respective resin sheets are formed of resins and solvents which have dissolution characteristics different from each other.

In applying the solvent, a bar coater, a blade coater, a spin coater, a dip coater, spray or other means can be used.

In milling the laminate of the resin sheets, dry milling by a jet mill, a centrifugal mill or others, or wet milling by a ball mill, a dino mill or others can be used. What is important is to reduce the laminate of the resins to resin pieces, and the present invention is not limited to the above-described means. Milling causes disuniform particle sizes. Classification may be performed by means of centrifugal separation, sedimentation, a cyclone or others.

Otherwise, the laminate of the resin sheets may be cut into resin pieces. In cutting the laminate, known means, such as a cutter, a tungsten wire, an excimer laser or others can be used. After cut, the respective resin pieces are separated by means of a supersonic homogenizer or others to thereby effectively prohibit fusion of the melted resins.

The resin pieces prepared by the milling or the cutting are heated to be sphered. The heating is made by hot air, or heating water, silicone oil or others. The resin pieces are subjected to the hot air or immersed in the water or the silicone oil to thereby be melted and sphered by a surface tension. Spherical particles are recovered by filtering, sedimentation, centrifugal separation or others, then rinsed and dried, and the multi-colored balls can be formed.

The thus-formed multi-colored balls, and a transparent insulating liquid are loaded in a void inside a binder, and the display device can be fabricated.

In loading the multi-colored balls and a transparent insulating liquid, the following methods can be used. (1) The multi-colored balls are dispersed in silicone rubber before cured. Then, the silicone rubber is cured. Then, the silicone rubber is swelled by silicone oil (refer to, e.g., the specification of U.S. Pat. No. 4,143,103). (2) The multi-colored balls are coated with solubilization resins by toluene, and dispersed in molten polyvinyl alcohol and cured. Then, the multi-colored balls are immersed in toluene (refer to, e.g., “A New Developed Electrical Twisting Ball Display”, M. Saitoh et al., Proc. of SID, Vol. 23/4 (1982)). (3) A dielectric liquid and the multi-colored balls are coated with a resin film by utilizing interfacial polymerization to thereby form micro capsules, and the micro capsules are dispersed in a transparent resin (refer to, e.g., the Laid-Open Japanese Patent Application No. Hei 8-234686 (1996)).

When, as the silicone rubber and the silicone oil carrying the multi-colored balls, dimethyl silicone oil is used as 2-liquid silicone rubber and silicone oil, a kinetic viscosity of the dimethyl silicone oil is preferably 1-500 cst. The dimethyl silicone oil whose kinetic viscosity is lower than 1 cst has a high volatility. The dimethyl silicone oil whose kinetic viscosity exceed 500 cst has too high viscosity, so that rotations of the multi-colored balls are hindered.

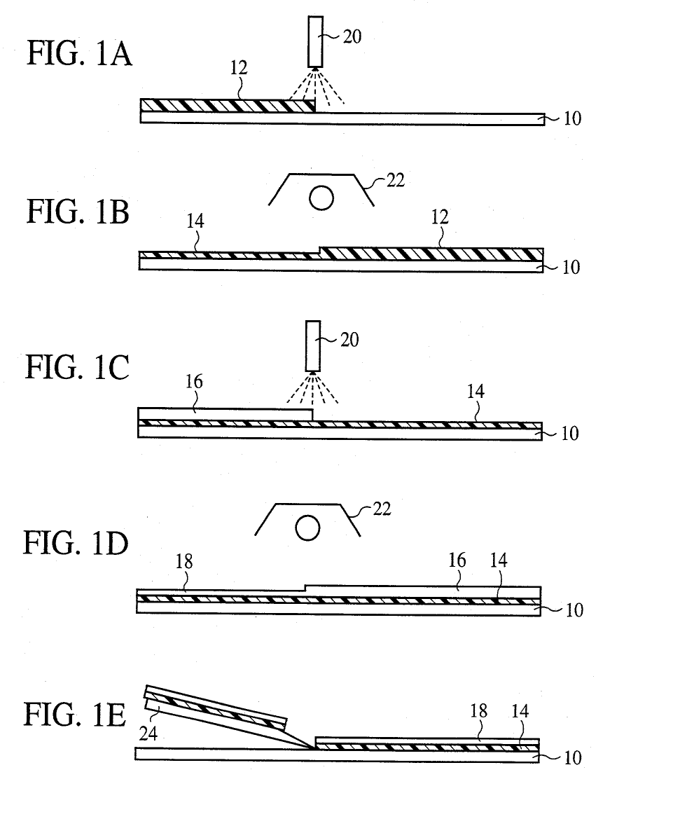

One example of the method for fabricating the laminate of the resin sheets in the method for fabricating the multi-colored ball according to the present invention will be explained with reference to FIGS. 1A-1E. The following method for fabricating the laminate is very effective to continuously form a plurality of resin sheets.

A solution 12 containing a black pigment used in the above-described first to the third method is applied, by, e.g., spray coating, to a glass substrate 10 from a spray nozzle 20 (FIG. 1A). FIG. 1A shows the application of the solution 12 to the glass substrate 10 by moving the glass substrate 10 from the right side to the left side as viewed in the drawing.

Then, the glass substrate 10 with the solution 12 applied to is heated to polymerize or dry the solution 12. Thus, the black resin sheet 14 is formed on the glass substrate 10 (FIG. 1B). FIG. 1B shows the exposure of the glass substrate 10 to a heater 22 by moving the glass substrate 10 from the right side to the left side as viewed in the drawing.

Then, a solution 16 containing a white pigment used in the above-described first to the third method is applied, by spray coating, to the glass substrate 10 with the black resin sheet 14 formed on (FIG. 1C). FIG. 1C shows the application of the solution to the glass substrate 10 by moving the glass substrate 10 from the right side to the left side as viewed in the drawing.

Then, the glass substrate 10 with the solution 16 applied to is heated to polymerize or dry the solution 16. Thus, a white resin sheet 18 is formed on the black resin sheet 14 (FIG. 1D). FIG. 1D shows the exposure of the glass substrate 10 to a heater 22 by moving the glass substrate 10 from the right side to the left side as viewed in the drawing.

Then, the laminate of the black resin sheet 16 and the white resin sheet 18 is released from the glass substrate 10 by using, e.g., a blade 24 (FIG. 1E).

Thus, the resin sheets-laminate of the black resin sheet and the white resin sheet can be formed.

### EXAMPLE 1

0.2 weight parts of carbon black (by Degussa AG) as a black pigment, 10 weight parts of V-65 (by Wako Pure Chemical Industries, Ltd.), 60 weight parts of styrene monomer and 40 weight parts of butyl acrylate were mixed and vacuum degassed, and an application solution was prepared. Then, the solution was applied to a glass substrate in a 200 μm-thick. Next, the glass substrate with the solution applied to was heated by an oven at 80° C. for 2 hours, and a 20 μm-thick black resin sheet was prepared.

Then, 1 weight part of titanium dioxide (by Titan Kogyo Kabusiki Kaisha) as a white pigment, 10 weight parts of V-65 (by Wako Pure Chemical Industries, Ltd.) as a polymerization initiator, 60 weight parts of styrene monomer and 40 weight parts of butyl acrylate were mixed and vacuum degassed, and an application solution was prepared. Then, the solution was applied to the glass substrate with the black resin sheet formed on in a 200 μm-thick. Next, the glass substrate with the solution applied to was heated by an oven at 80° C. for 2 hours, and a 20 μm-thick white resin sheet was formed on the black resin sheet.

Next, the laminate of the resin sheets was released from the glass substrate and milled, and resin pieces of 80-250000 μm² were prepared. At this time, no release took place between the white resin and the black resin.

Then, the resin pieces were immersed in silicone oil (by Dow Corning Toray Silicone Co., Ltd.). The resin pieces were melted and formed by a surface tension into multi-colored spherical particles. These multi-colored particles were rinsed by low-viscosity silicone oil and recovered.

### EXAMPLE 2

2 weight parts of carbon black (by Degussa AG) as a black pigment, 10 weight parts of V-65 (by Wako Pure Chemical Industries, Ltd.) as a polymerization initiator, 60 weight parts of styrene monomer and 40 weight parts of butyl acrylate were mixed. Then, the solution was polymerized (temperature: 80° C., 30 minutes) while being slowly agitated in a separable flask equipped with a coiled condenser, and a black prepolymer was prepared. The prepolymer was vacuum degassed and then was applied to a glass substrate in a 20 μm-thick. Then, the glass substrate with the prepolymer applied to was heated by an oven at 80° C. for 1 hour, and a 20 μm-thick black resin sheet was formed.

Then, 10 weight parts of titanium dioxide (by Titan Kogyo Kabusiki Kaisha) as a white pigment, 10 weight parts of V-65 (by Wako Pure Chemical Industries, Ltd.) as a polymerization initiator, 60 weight parts of styrene monomer and 40 weight parts of butyl acrylate were mixed. Then, the solution was polymerized (temperature: 80° C., 30 minutes) while being slowly agitated in a separable flask equipped with a coiled condenser, and a white prepolymer was prepared. The prepolymer was vacuum degassed and was applied to the glass substrate with the black resin sheet formed on in a 20 μm-thick. Then, the glass substrate with the prepolymer applied to was heated by an oven at 80° C. for 1 hour, and a 20 μm-thick white resin sheet was formed on the black resin sheet.

Then, the laminate of the resin sheets is released from the glass substrate and then cut into 150 μm×150 μm pieces with a 150 μm-pitch round tooth.

Then, the resin pieces were immersed in silicone oil (by Dow Corning Toray Silicone Co., Ltd.). The resin pieces were melted and formed by a surface tension into multi-colored spherical particles. These multi-colored particles were rinsed by low-viscosity silicone oil and recovered.

### EXAMPLE 3

2 weight parts of carbon black (by Degussa AG) as a black pigment, 10 weight parts of V-65 (by Wako Pure Chemical Industries, Ltd.) as a polymerization initiator, 60 weight parts of styrene monomer and 40 weight parts of butyl acrylate were mixed. Then, the solution was polymerized (temperature: 80° C., 30 minutes) while being slowly agitated in a separable flask equipped with a coiled condenser, and a black prepolymer was prepared. The prepolymer was vacuum degassed and then was applied to a glass substrate in a 3 μm-thick by a spin coater. Then, the glass substrate with the prepolymer applied to was heated by an oven at 80° C. for 1 hour, and a 3 μm-thick black resin sheet was formed.

Then, 10 weight parts of titanium dioxide (by Titan Kogyo Kabusiki Kaisha) as a white pigment, 10 weight parts of V-65 (by Wako Pure Chemical Industries, Ltd.) as a polymerization initiator), 60 weight parts of styrene monomer and 40 weight parts of butyl acrylate were mixed. Then, the solution was polymerized (temperature: 80° C., 30 minutes) while being slowly agitated in a separable flask equipped with a coiled condenser, and a white prepolymer was prepared. The prepolymer was vacuum degassed and was applied to the glass substrate with the black resin sheet formed on in a 3 μm-thick. Then, the glass substrate with the prepolymer applied to was heated by an oven at 80° C. for 1 hour, and a 3 μm-thick white resin sheet was formed on the black resin sheet.

Then, the laminate of the resin sheets was released from the glass substrate and was cut into 150 μm×150 μm pieces with a 150 μm-pitch round tooth.

Then, the resin pieces were immersed in silicone oil (by Dow Corning Toray Silicone Co., Ltd.). The resin pieces were melted and formed by a surface tension into multi-colored spherical particles. These multi-colored particles were rinsed by low-viscosity silicone oil and recovered.

### EXAMPLE 4

30 mass parts of titanium dioxide (by Titan Kogyo Kabusiki Kaisha) as a white pigment, and 270 mass parts of polyester resin (softening point: 93° C.) were kneaded by a roll mill, and a massive white resin was prepared. 294 mass parts of polystyrene resin (softening point: 110° C.) and 6 mass parts of carbon black (by Cabot Corp.) as a black pigment were kneaded by a roll mill, and a massive black resin was prepared.

Then, the white polyester resin was dissolved in tetrohydrofuran and vacuum dried, and was adjusted to be stringy. The solution was applied to a polyimide film in a 20 μm-thick by a blade coater and dried at 50° C., and a white resin sheet was prepared.

Then, the black polystyrene resin was dissolved in toluene and vacuum dried, and was adjusted to be stringy. The solution was applied to the white resin sheet in a 20 μm-thick by a blade coater, and a black resin sheet was formed on the white resin sheet.

Next, the laminate of the resin sheets were cut into 300 μm×300 μm resin pieces with a 300 μm-pitch metal blade.

Then, the resin pieces were immersed in silicone oil (by Dow Corning Toray Silicone Co., Ltd.). The resin pieces were melted and formed by a surface tension into multi-colored spherical particles. These multi-colored particles were rinsed by low-viscosity silicone oil and recovered.

### EXAMPLE 5

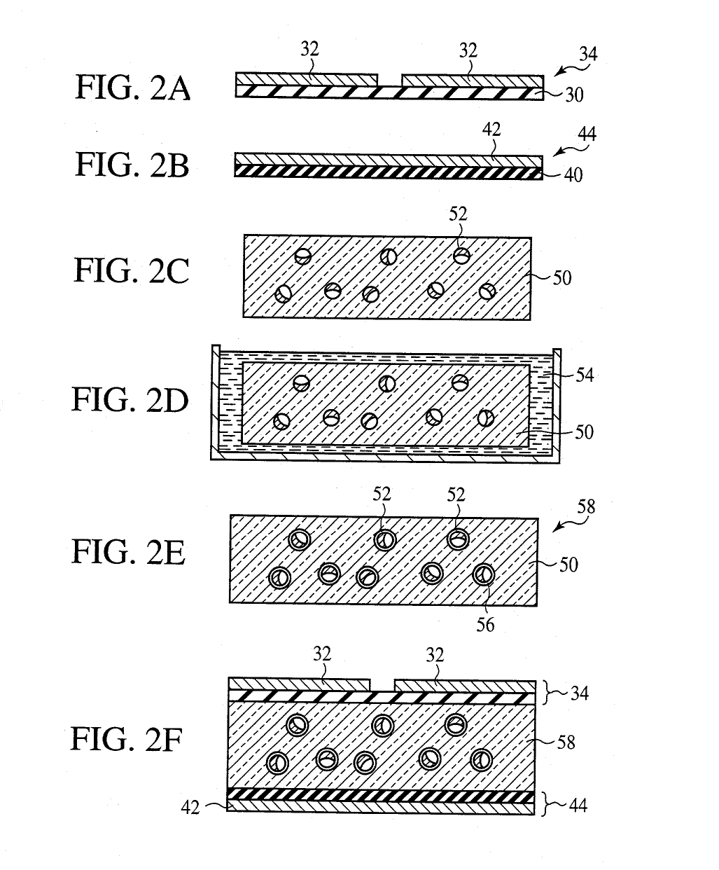

As discrete electrodes 32 for driving the display, aluminum was evaporated on a synthetic paper (thickness: 80 μm, by Yupo Corp.), and the lower sheet 34 was prepared (FIG. 2A). As a common electrode 34, ITO was evaporated uniformly on a PET film 40 (thickness: 150 μm), and the upper sheet 44 of the display device was prepared (FIG. 2B).

The multi-colored balls 52 prepared in accordance with Examples 1 to 4 were dispersed in a 2-liquid silicone rubber KE106 (by Dow Corning Toray Silicone Co., Ltd.) and was applied to a Teflon (registered trademark) resin plate in a 300 μm-thick by blade coating method, and cured in the atmosphere of 50° C. for 8 hours (FIG. 2C).

Then, the silicone rubber 50 was immersed in silicone oil 54 (SH200-10 cst: by Dow Corning Toray Silicone Co., Ltd.) for 12 hours (FIG. 2D).

Thus, the silicone rubber 50 swells to admit the silicone oil 54 between the multi-colored balls 52 and the silicone rubber 50 to thereby form a void 56 where the multi-colored balls 52 can migrate (FIG. 2E).

Then, the upper sheet 44 of PET film and the lower sheet 34 of synthetic paper are adhered to the thus-formed display layer 58, and the sheet-type display device was fabricated (FIG. 2F).

When a voltage is applied between the discrete electrodes 32 and the common electrode 42 of the sheet-type display device, prescribed images can be displayed.

What is claimed is:

1. A method for fabricating a multi-colored ball comprising the step of:
applying to a first resin sheet having a first color and a first charge characteristic a solution containing at least a resin and/or a monomer which is a precursor of a resin, and a coloring agent having a second color and a second charge characteristic;
polymerizing or drying the solution to thereby form a second resin sheet having the second color and the second charge characteristic on the first resin sheet;
cutting or milling a laminate of the first resin sheet and the second resin sheet; and
sphering the cut or milled laminate by heating to form a multi-colored ball having a first region having the first color and the first charge characteristic and a second region having the second color and the second charge characteristic.

2. A method for fabricating a multi-colored ball according to claim 1, further comprising the steps of:
applying to a substrate a solution containing at least a resin and/or a monomer which is precursor of a resin, and a coloring agent having the first color and the first charge characteristic to thereby form the first resin sheet having the first color and the first charge characteristic.

3. A method for fabricating a multi-colored ball according to claim 1, wherein
in the step of forming the first resin sheet, the solution containing the monomer, the coloring agent and a polymerization initiator is applied and polymerized to thereby form the first resin sheet.

4. A method for fabricating a multi-colored ball according to claim 2, wherein
in the step of forming the second resin sheet, the solution containing the monomer, the coloring agent and a polymerization initiator is applied and polymerized to thereby form the second resin sheet.

5. A method for fabricating a multi-colored ball according to claim 1, wherein
in the step of forming the first resin sheet, the solution containing a prepolymer containing the resin and the monomer, the coloring agent and a polymerization initiator is applied and polymerized to thereby form the first resin sheet.

6. A method for fabricating a multi-colored ball according to claim 2, wherein
in the step of forming the second resin sheet, the solution containing a prepolymer containing the resin and the monomer, the coloring agent and a polymerization initiator is applied and polymerized to thereby form the second resin sheet.

7. A method for fabricating a multi-colored ball according to claim 1, wherein
in the step of forming the first resin sheet, the solution containing the resin and the coloring agent is applied and dried to thereby form the first resin sheet.

8. A method for fabricating a multi-colored ball according to claim 2, wherein
in the step of forming the second resin sheet, the solution containing the resin and the coloring agent is applied and dried to thereby form the second resin sheet.

9. A method for fabricating a multi-colored ball according to claim 1, wherein
the solution has a 3-100 Pa·s viscosity.

10. A method for fabricating a multi-colored ball according to claim 3, wherein
the solution is polymerized by heating.

11. A method for fabricating a multi-colored ball according to claim 5, wherein
the solution is polymerized by heating.

12. A method for fabricating a multi-colored ball according to claim 3, wherein
the solution is polymerized by application of UV radiation.

13. A method for fabricating a multi-colored ball according to claim 5, wherein
the solution is polymerized by application of UV radiation.

14. A method for fabricating a multi-colored ball according to claim 1, wherein
a thickness of the laminate is 1-10000 μm.

15. A method for fabricating a multi-colored ball according to claim 1, wherein
the multi-colored ball has a white color region and a black color region, the white color region contains titanium dioxide, and the black color region contains carbon black.

16. A method for fabricating a multi-colored ball according to claim 3, wherein
the solution contains styrene monomer and butyl acrylate.

17. A method for fabricating a multi-colored ball according to claim 5, wherein
the solution contains styrene monomer and butyl acrylate.

18. A method for fabricating a display device which display by rotating a multi-colored ball having 2 surface regions having optical characteristics different from each other, the method comprising the steps of:
forming a multi-colored ball by a method for fabricating a multi-colored ball according to claim 1;
dispersing the multi-colored ball in a transparent display medium and curing the same to thereby form a sheet-type display layer containing the multi-colored ball; and
forming electrodes respectively on a front surface of the display layer and a back surface thereof.

19. A method for fabricating a display device according to claim 18, wherein
the multi-colored ball has a white color region, and the white color region contains titanium dioxide having a particle diameter of 100-500 nm.

20. A method for fabricating a display device according to claim 19, wherein
the titanium dioxide has the anatase-type crystal structure.
